(19) United States
(12) Patent Application Publication
(10) Pub. No.: US 2009/0105940 A1
(43) Pub. Date: Apr. 23, 2009

(54) Route calculation based on traffic events

(75) Inventor: Ronen Bitan, Har Dar (IL)

Correspondence Address: RONEN BITAN, 95 MURAL STREET, 6TH FLOOR, RICHMOND HILL, ONTARIO, L4B 3G2, CA

(73) Assignee: Destinator Technologies, Inc.

(21) Appl. No.: 11/977,268

(22) Filed: Oct. 23, 2007

(51) Int. Cl. G01C 21/34; G01S 5/00; G06F 17/00

(52) U.S. Cl. 701/201

(57) ABSTRACT

Based on an origin location and a destination location, a navigation device is configured to provide an initial route. Traffic messages describing traffic events are received by the navigation device. Based on a location code in each of the traffic messages, the navigation device determines a traffic event delay if the location code corresponds to any remaining segment(s) of the initial route. If at least one of the traffic messages corresponds to any remaining segment(s) of the initial route, a travel delay is calculated based on one or more traffic event delays. The navigation device calculates a new route from the current location to the destination location, and, if a new travel time of the new route is less than a remaining travel time of the initial route from the current location to the destination location plus the travel delay, the navigation device outputs the new route.

### BACKGROUND

1. Field of the Invention

This invention relates generally to the field of global positioning systems (GPS) and more specifically to route calculation based on traffic events.

2. Description of the Related Art

A GPS-enabled device is able to determine a current location. As is known in the art, the GPS-enabled device includes road maps or topographical maps and is able to correlate its current location to these maps. Further, using these maps and its known current location, the GPS-enabled device can calculate a route to a destination location and provide that route to a user.

Traffic events such as accidents, congestion, roadwork, weather conditions, or the like can delay travel on roadways. Currently, the GPS-enabled device may receive previously prepared traffic roadmaps or other indications of traffic events. If a traffic event is on the provided route, the GPS-enabled device may automatically calculate a new route or provide an option to the user to calculate the new route.

However, depending upon the type and extent of the traffic event, an automatically calculated new route may actually require more time to travel than the original route with the delay. For example, to avoid a five minute delay, a new route requiring ten additional minutes to travel may automatically be provided. The user, however, likely would have preferred to remain on the original route.

Similarly, if the user is given the option of having the GPS-enabled device calculate the new route, the user may inadvertently have a new route calculated when the original route with the travel delay would have required less travel time. Por example, the user may have a new route calculated based on inadequate information about the traffic event and/or the new route.

Therefore, to provide a user with a route to a destination location requiring the least amount of travel time, there is a need for automatically providing a new route based on traffic events.

### SUMMARY OF INVENTION

A Global Positioning System (GPS)-enabled navigation device is configured to determine whether to calculate a new route based on traffic events. The navigation device provides an initial route based on an origin location and a destination location. If a traffic message is received that includes information about a traffic event along a remaining portion of the initial route, a traffic event delay is determined. A total travel delay is then calculated by summing the determined traffic event delays. A new route is calculated to avoid the traffic event(s). A travel time of the new route is compared to a travel time of the initial route plus the travel delay. If the travel time of the new route is shorter than the travel time of the initial route plus the travel delay, the new route is provided to the user.

According to various embodiments, a system comprises a global positioning system, a traffic message receiver, a delay module, a route module and a comparison module. The global positioning system module is configured to determine a current location. The traffic message receiver is configured to receive traffic messages each having an event code and a location code. The delay module is configured to determine a traffic event delay for each of the traffic messages having a location code that corresponds to a remaining segment of a first route from an origin location to a destination location. The delay module is further configured to calculate a travel delay based on one or more of the traffic event delays. The route module is configured to calculate a new route from the current location to the destination location, the new route having a new travel time. The comparison module is configured to compare the new travel time of the new route to a remaining travel time of the first route between the current location and the destination location plus the travel delay and output the new route if the new travel time is less than the remaining travel time plus the travel delay.

According to various embodiments, a method comprises determining a current location of a navigation device; receiving one or more traffic messages each having an event code and a location code; determining a traffic event delay for each of the one or more traffic messages where the location code of the one or more traffic messages corresponds to a remaining segment of a first route from an origin location to a destination location; calculating a travel delay based on one or more of the traffic event delays; calculating a new route from the current location to the destination location, the new route having a new travel time; comparing the new travel time of the new route to a remaining travel time of the first route from the current location to the destination location plus the travel delay; and outputting the new route if the new travel time is less than the remaining travel time plus the travel delay.

According to various embodiments, a computer readable medium has embodied thereon instructions executable by a processor for performing a method for calculating a route based on traffic events. The method comprises determining a current location of a navigation device; receiving one or more traffic messages each having an event code and a location code; determining a traffic event delay for each of the one or more traffic messages where the location code corresponds to a remaining segment of a first route from an origin location to a destination location; calculating a travel delay based on one or more of the traffic event delays; calculating a new route from the current location to the destination location, the new route having a new travel time; comparing the new travel time of the new route to a remaining travel time of the first route from the current location to the destination location plus the travel delay; and outputting the new route if the new travel time is less than the remaining travel time plus the travel delay.

### BRIEF DESCRIPTION OF THE DRAWINGS

FIG. 1 is an illustration of an exemplary path of a traffic message to the navigation device;

FIG. 2 is a block diagram of a navigation device according to various embodiments;

FIG. 3 is a flowchart of an exemplary process of calculating a new route based on traffic events according to various embodiments; and

FIG. 4 is an exemplary portion of a delay table according to various embodiments.

### DETAILED DESCRIPTION

A Global Positioning System (GPS)-enabled navigation device is configured to determine its current location and provide an initial route from an origin location to a destination location. The navigation device receives traffic messages each containing an event code and a location code corresponding to a traffic event. The navigation device is configured to determine whether any of the received traffic events are on remaining segment(s) of the initial route based on the location code in the corresponding traffic message and the current location.

If any traffic events are on remaining segment(s) of the initial route, the navigation device is configured to determine a traffic event delay caused by the traffic event based on the event code in the traffic message. In some embodiments, the traffic event delay is also based on the location code in the traffic message. A travel delay is calculated by summing traffic event delay(s) corresponding to each of the traffic events along the remaining segment(s) of the initial route. The travel delay is optionally compared to a threshold delay to determine whether to calculate a new route. The new route, which bypasses at least one of the traffic events, from the current location to the destination location is calculated.

To determine whether to provide the new route to the user, the travel time of the new route to reach the destination location is calculated. The travel delay is added to the remaining travel time of the initial route. The new travel time is compared to the remaining travel time plus the travel delay and if the new travel time is less than the remaining travel time plus the travel delay, the new route is output to the user.

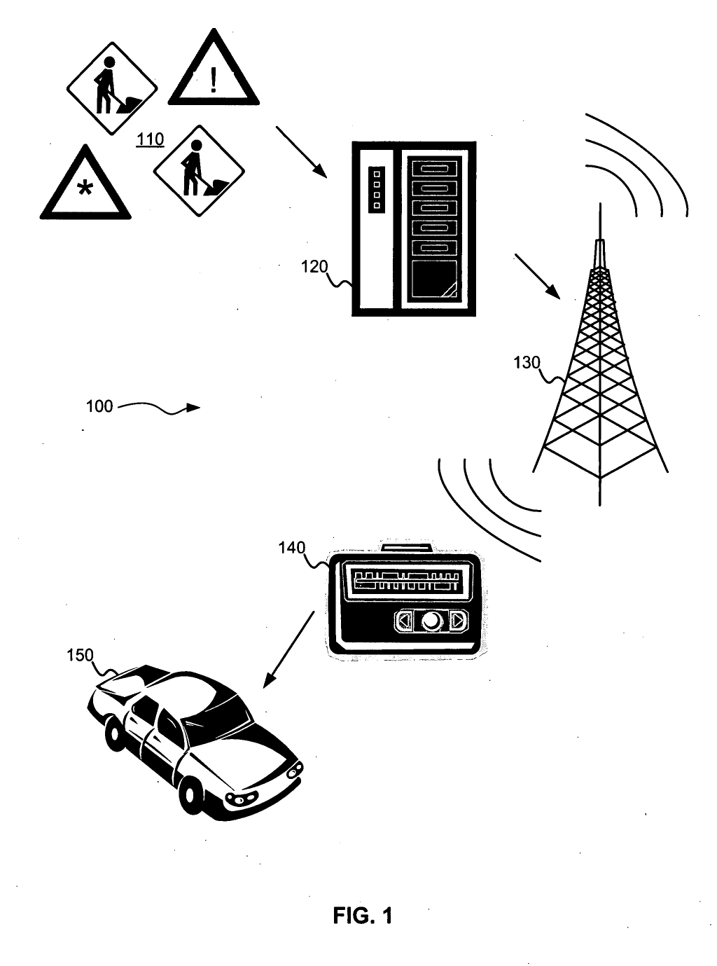

FIG. 1 is an illustration of an exemplary path 100 of a traffic message to the navigation device. The path 100 is used to communicate information about traffic events from the location of the traffic event to a traffic message receiver installed in, for example, an automobile.

At the roadway 110 a traffic event occurs. The traffic event may be construction, an accident, traffic congestion, a weather condition, or the like. Information about the traffic event is communicated by a motorist, emergency services, a traffic monitoring system, or the like from the roadway 110 to a traffic information center 120.

The traffic information center 120 collates the traffic event information and generates a traffic message. The traffic message comprises an event code corresponding to the type of the traffic event and a location code corresponding to the location of the traffic event. The location code may correspond to a point location or a segment of a roadway.

In some embodiments, the traffic message is a Traffic Message Channel (TMC) message according to the ALERT-C coding protocol, as is known in the art. TMC messages include numerical codes to provide information about the traffic event including an event description, location affected, direction and extent of roadway affected, duration of the traffic event, and diversion advice. The numerical codes can be decoded using a publicly available database, as is known in the art. Examples of TMC providers include: TMC Pro, Premium TMC, InfoBlu, Intelematics, TrafficMaster, ClearChannel, Navteq, and TMC. Alternatively or additionally, the traffic message comprises other traffic message data in accordance with one or more other standards such as Traffic Protocol Experts Group (TPEG).

The traffic message is then broadcast by a broadcast station 130. The broadcast station 130 may broadcast the traffic messages via a communications medium such as frequency-modulated (FM) radio, amplitude modulated (AM) radio, cellular communications, satellite radio, Radio Data System-Traffic Message Channel (RDS-TMC), Wireless Fidelity (Wi-Fi), Worldwide Interoperability for Microwave Access (Wi-Max), digital radio, digital audio broadcasting (DAB), digital television (DTV), high definition television (HDTV), or the like. Cellular communications include protocols such as Code Division Multiple Access (CDMA), Universal Mobile Telecommunications System (UMTS), Evolution Data Only (EVDO), and Time Division Multiple Access (TDMA).

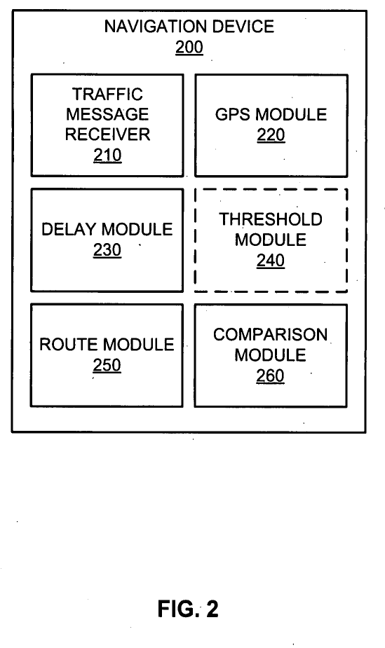

The traffic message is received by the traffic message receiver 140 configured to receive traffic messages from the broadcast station 130. The traffic message receiver 140 is configured to decode the event code in the traffic message using, for example, information from the publicly available database of event codes. In embodiments using the TMC protocol, the event code may be accompanied by additional information such as a quantifier. In embodiments in which TPEG data is received, a portion of the data is processed by the traffic message receiver 140 to determine an event type. The traffic message receiver 140 additionally determines the location of the traffic event using information from a separate database that correlates the location codes to a road map. The traffic message receiver 140 may be an embedded component of a navigation device (e.g., a GPS device) discussed herein, at least, in connection with FIG. 2.

The traffic message receiver 140 is typically part of a navigation device in an automobile 150. Thus, the driver of the automobile 150 has access to current traffic information. In various embodiments, the navigation device is a handheld device. The navigation device is discussed further herein, at least, in connection with FIG. 2.

FIG. 2 is a block diagram of a navigation device 200 according to various embodiments. The navigation device 200 comprises a traffic message receiver 210, a GPS module 220, a delay module 230, an optional threshold module 240, a route module 250, and a comparison module 260.

The navigation device 200 comprises one or more computing devices including computer readable media, a processor, and/or logic. For example, the navigation device 200 may comprise a processor (not shown) configured to execute computing instructions stored in the computer readable medium (not shown). These instructions may be embodied in software and divided into the traffic message receiver 210, the GPS module 220, the delay module 230, the optional threshold module 240, the route module 250, and the comparison module 260. The computer readable medium can be an integrated circuit (IC) memory chip, such as, for example, static random access memory (SRAM), dynamic random access memory (DRAM), synchronous DRAM (SDRAM), non-volatile random access memory (NVRAM), and read only memory (ROM), such as erasable programmable ROM (EPROM), electrically erasable programmable ROM (EPROM), and flash memory. Alternatively, the navigation device 200 may comprise one or more chips with logic circuitry, such as, for example, an application specific integrated circuit (ASIC), a processor, a microprocessor, a microcontroller, a field programmable gate array (FPGA), a programmable logic device (PLD), a complex programmable logic device (CPLD), or other logic device.

The traffic message receiver 210, like the traffic message receiver 140, is configured to receive traffic messages from a traffic message center, such as traffic message center 120, via a broadcast station, such as broadcast station 130. The traffic message receiver 210 is configured to receive the traffic messages via at least one of the communications mediums discussed herein, at least, in connection with the broadcast station 130.

The traffic message receiver 210, upon receiving a TMC traffic message, retrieves information about the type of event and the event location from a copy of the publicly available database of event codes stored in the navigation device 200, as is described herein, at least, in connection with the traffic message receiver 140. In an embodiment of the traffic message receiver 210, the description of the traffic event including the event location is displayed to the user in a “traffic message inbox” interface (not shown).

The traffic message receiver 210 may, additionally or alternatively, receive other types of traffic messages including, for example, TPEG data. The TPEG data may be processed as will be apparent to one skilled in the art to identify a delay and/or calculate a new route. The traffic message receiver 210 may receive traffic messages in accordance with one or more standards for traffic messages.

The GPS module 220 is configured to determine a current location of the navigation device 200 as is known in the art. The GPS module 220 additionally correlates the current location to at least one road map.

The delay module 230 is configured to determine a travel delay based on the traffic message(s) and an initial route. The delay module 230 is configured to access the initial route from an origin location to a destination location as well as access the current location and determine whether the event location(s) are along remaining segment(s) of the initial route. The remaining segment(s) of the initial route include any portion of the route between the current location and the destination location. The initial route may be generated by the route module 250, generated by another module (not shown), or received from another device. The origin location may be received from a user, a previous current location of the navigation device 200, or a selected location from a menu, as is known in the art. The destination location may be received from the user by entering an address, selecting a location from a menu, or selected from a list of previous or favorite destination locations, as is known in the art.

The delay module 230 is configured to calculate a travel delay caused by one or more traffic events along the remaining segment(s). To illustrate, if there is more than one traffic event along the remaining segment(s) of the initial route, the delay module is configured to identify a traffic event delay caused by each of the traffic events. The traffic event delays are summed to calculate the overall travel delay. If there is only one traffic event along the remaining segment(s), the travel delay is equal to the traffic event delay.

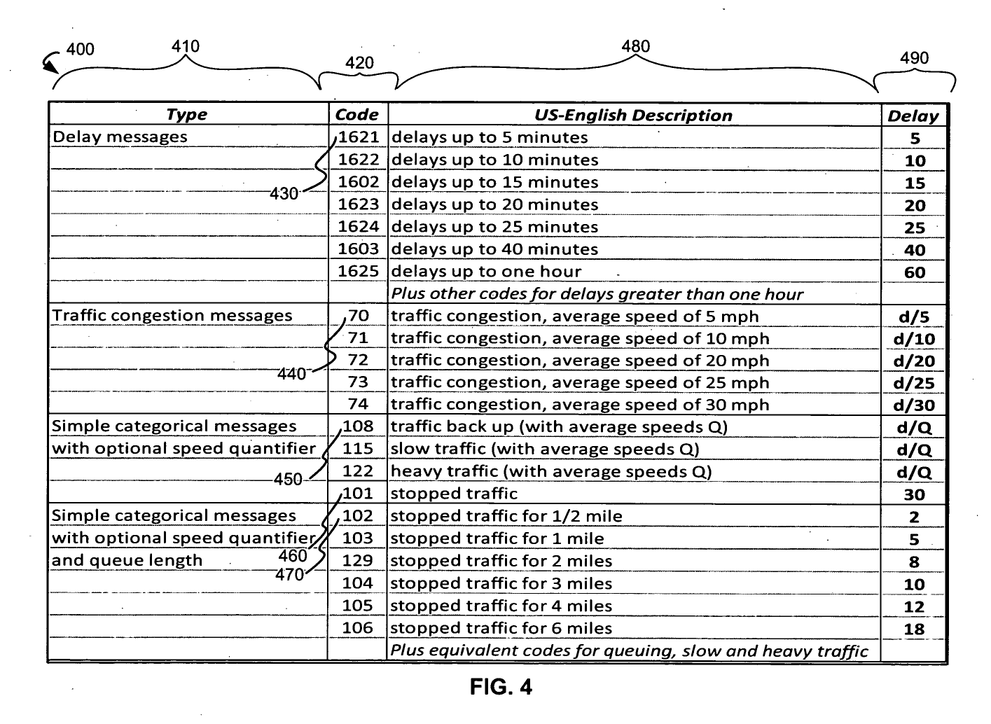

The delay module 230 is configured to access a delay table to determine each traffic event delay. An exemplary portion of the delay table is discussed below with reference to FIG. 4. In some embodiments, the delay table is an appended portion of the copy of the publicly available database of event codes stored in the navigation device 200. A delay expression corresponding to the event code is retrieved from the delay table. The delay expression may be one of two types.

The first type of delay expression is a value indicating an amount of time of the traffic event delay. For example, the delay table includes a delay expression of “1” for an event code characterized as a “delay of one minute.”

The second type of delay expression is a quotient of distance divided by velocity to be used in calculating a traffic event delay. The second type of delay expression is retrieved if the event code corresponds to an event description that indicates an average velocity, such as “average speed is ten miles per hour.” The second type of delay expression is based on the equation:

t_{d}=(d/v)−t₀

where t_{d} represents the traffic event delay, d represents the length of the segment of the roadway based on the location code, v represents the average velocity indicated by the event code, and to represents the travel time corresponding to the segment of the roadway if there are no traffic events.

The traffic event delays determined using either or both types of delay expressions are summed to calculate the travel delay.

The optional threshold module 240 is configured to compare the travel delay determined by the delay module 230 to a threshold delay. The threshold delay is the shortest delay for which a new route is to be calculated. To illustrate, if the travel delay is four minutes and the threshold delay is five minutes, a new route will not be calculated because the travel delay does not meet or exceed the threshold delay. In some embodiments, the threshold delay is set to a default value which is modifiable by the user. In some embodiments, the threshold module 240 is included in the delay module 230.

The route module 250 is configured to calculate a new route from the current location to the destination location if a travel delay exists and, in some embodiments, if the travel delay meets the threshold delay. The route module 250 is configured to calculate the new route so as to avoid one or more of the affected remaining segments of the initial route. In some embodiments, the route module 250 may also have provided the initial route from the origin location to the destination location.

The comparison module 260 is configured to compare a new travel time of the new route to a remaining travel time of the initial route between the current location and the destination location plus the travel delay and output the new route if the new travel time is less than the remaining travel time plus the travel delay. The new travel time is the amount of time to reach the destination location from the current location via the new route. The new travel time may itself include a travel delay based on one or more traffic event(s) located along the new route. The remaining travel time is typically calculated by the GPS module 220 on an ongoing basis as the user follows the initial route. Because a user typically wishes to reach the destination location as quickly as possible, if the new travel time is less than the remaining travel time plus the travel delay, the new route is output to the user. In some embodiments, the user is instead given a choice whether to switch to the new route.

It will be appreciated that the navigation device 200 illustrated in FIG. 2 is merely an illustrative and non-limiting example of a navigation device according to the present invention. As such, it should be appreciated that the present invention may be embodied in alternate forms.

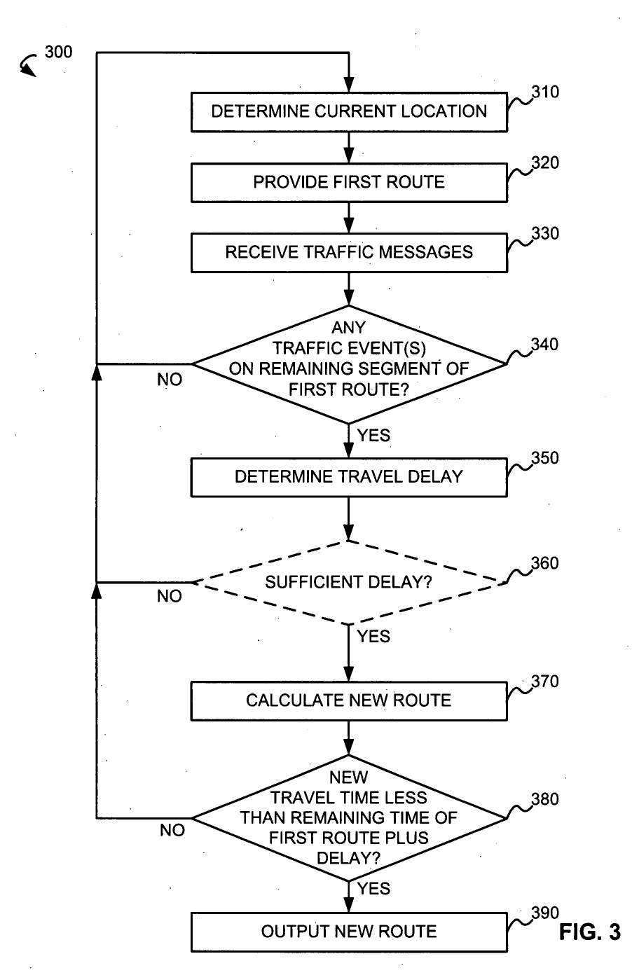

FIG. 3 is a flowchart of an exemplary process 300 of calculating a new route based on traffic events according to various embodiments. The process 300 may be performed by the navigation device 200.

In a step 310, a current location is determined. A GPS module such as the GPS module 220 (FIG. 2) determines the current location as is known in the art.

In a step 320, a first route is provided to the user. The first route is the initial route from the origin location to the destination location. The first route may be received as an input from another device or may be determined by the route module 250 (FIG. 2). The first route is typically the fastest route from the origin location to the destination location if there is no travel delay. In some embodiments, the first route is selected to avoid secondary roads, be the shortest distance, or based on similar or other criteria.

In a step 330, traffic messages about traffic events are received by a traffic message receiver such as the traffic message receiver 210 (FIG. 2).

In a step 340, a determination is made as to whether any of the traffic events affect a remaining segment of the first route based on the current location. In some embodiments, the determination is made by the delay module 230 (FIG. 2). If none of the traffic events affect any of the remaining segment(s) of the first route, the process 300 returns to step 310.

In a step 350, if at least one of the traffic events corresponds to any of the remaining segment(s) of the first route, a travel delay is determined. The travel delay may be a summation of more than one traffic event delay if more than one traffic event corresponds to the remaining segment(s) of the first route. The travel delay is determined by the delay module 230 as described in connection with FIG. 4.

In an optional step 360, a determination is made as to whether the travel delay is sufficient to warrant calculating a new route. This determination is made by comparing the travel delay to the threshold delay as described in connection with the threshold module 240. If the travel delay is not sufficient, the process 300 returns to the step 310.

In a step 370, if the travel delay is sufficient, a new route from the current location to the destination location is calculated. The new route may be calculated as described in connection with the route module 250 (FIG. 2). In some embodiments, more than one alternative new route from the current location to the destination location is calculated. In these embodiments, the alternative route having the shortest travel time (which may take into account received traffic messages corresponding to segments of the new route) is selected as the new route.

In a step 380, a determination is made as to whether a new travel time of the new route is less than the remaining travel time of the first route plus the travel delay. The determination may be made by the comparison module 260 (FIG. 2). If the new travel time is greater than the remaining time plus the travel delay, the process 300 returns to the step 310.

In a step 390, if the new travel time is less than the remaining travel time plus the travel delay, the new route is output to the user. The output may include an option to maintain the first route as described in connection with the comparison module 260 (FIG. 2).

The process 300 may be repeated for additional traffic messages, a new current location, or for the new route. It is understood that steps 310, 320, and 330 may be performed in any order.

FIG. 4 is an exemplary portion of a delay table 400 according to various embodiments. The delay table 400 identifies, at least, specific event codes that may be included in a TMC traffic message and traffic event delays associated with each. The delay table 400 may be accessed by the delay module 230. As will be understood by those skilled in the art, information in the delay table 400 may be stored in other data structures.

In an optional column 410, a type of traffic event is listed. In traffic messages transmitted via the Traffic Message Channel (TMC), the event codes are grouped into types. The types provide an overall description of the events in the group.

In a column 420, event codes are listed. The event codes are numbers corresponding to event descriptions in a column 480. The event codes are shown as decimal numbers but may be broadcast by a traffic information center as binary equivalents.

In the column 480, the event descriptions of each of the event codes are listed. Some event descriptions, such as the event description for event code “1621” 430, include a traffic event delay in the description. Other event descriptions, such as the description for event code “70” 440, include an average speed or velocity. Still other event descriptions indicate that there is an optional quantifier; Q, which may be included in the traffic message to indicate the average speed of traffic. For example, the event description for event code “108” 450 includes a note that the traffic event is a “traffic back up (with average speeds Q).” Other event descriptions include limited information for determining a traffic event delay. For example, event code “101” 460 corresponds to the event description “stopped traffic” and event code “102” 470 corresponds to the event description “stopped traffic for ½ mile.”

In a column 490, a delay expression corresponding to each event code is listed. The delay expression is a mathematical expression that includes one or more values, variables or operators to represent the traffic event delay or a recalculated travel time through a segment corresponding to the location code. The delay expression is based on information in the description of the event code. If the event description includes a traffic event delay, the delay expression is a single value. For example, the delay expression for the event code “1621” 430 corresponding to an event description “delays up to 5 minutes” is simply the value “5.”

If the event description indicates the average speed of traffic, or refers to a quantifier that indicates the average speed of traffic, the delay expression is used to recalculate travel time for an affected segment and has the form of d/v where d represents distance and v represents the average speed. To determine the distance, the delay module 230 may retrieve the location code included in a received traffic message. The location code corresponds to the affected segment of a roadway and the length of the affected segment is the distance. Thus, to obtain the recalculated travel time, the distance is divided by the average speed of traffic. For example, for the event code “70” 440, the delay expression is “d/5.” Further, for the event code “108” 450, the delay expression is “d/Q.” The traffic event delay is the difference between the recalculated travel time and the travel time corresponding to the affected segment if there are no traffic events.

If the event description includes limited information about the traffic event delay, the traffic event delay may be assigned or estimated. For example, the event code “101” 460 corresponds to a delay expression of “30.” For the event code “102” 470, the delay expression is a smaller value, “2,” at least because it is known that traffic is stopped for a short distance.

In some embodiments, the delay table 400 may include more than one column of delay expressions. The additional columns may provide different delay expressions to adjust for differences between traffic message providers or event locations. For example, one provider may describe a traffic event as “slow traffic” while another provider may describe the same traffic event as “stopped traffic.” While the delay table 400 includes event codes within the TMC protocol, it is understood that the delay table 400 may additionally or alternatively include delay information received in accordance with another standard, e.g., the TPEG protocol.

Several embodiments are specifically illustrated and/or described herein. However, it will be appreciated that modification and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a global positioning system module configured to determine a current location;
a traffic message receiver configured to receive traffic messages each having an event code and a location code;
a delay module configured to determine a traffic event delay for each of the traffic messages having a location code that corresponds to a remaining segment of a first route from an origin location to a destination location;
the delay module further configured to calculate a travel delay based on one or more of the traffic event delays;
a route module configured to calculate a new route from the current location to the destination location, the new route having a new travel time; and
a comparison module configured to compare the new travel time of the new route to a remaining travel time of the first route between the current location and the destination location plus the travel delay and output the new route if the new travel time is less than the remaining travel time plus the travel delay.

2. The system of claim 1, further comprising a threshold module configured to compare the travel delay to a threshold delay and determine whether to have the delay module calculate the new route.

3. The system of claim 1, wherein the delay module configured to determine a traffic event delay calculates a length of time based on a speed of traffic and the location code corresponding to the remaining segment.

4. The system of claim 1, wherein the delay module configured to determine a traffic event delay is based on a length of time indicated by the event code of the traffic message.

5. The system of claim 1, wherein the traffic messages are in accordance with a standard.

6. The system of claim 1, wherein the traffic message receiver receives the traffic messages via a frequency-modulated (FM) radio receiver.

7. The system of claim 1, wherein the traffic message receiver receives the traffic messages via a cellular communication.

8. The system of claim 1, wherein the traffic message receiver receives the traffic messages via a satellite radio receiver.

9. The system of claim 1, wherein the delay module configured to calculate the travel delay based on one or more of the traffic event delays sums the one or more traffic event delays.

10. A method comprising:
determining a current location of a navigation device;
receiving one or more traffic messages each having an event code and a location code;
determining a traffic event delay for each of the one or more traffic messages where the location code of the one or more traffic messages corresponds to a remaining segment of a first route from an origin location to a destination location;
calculating a travel delay based on one or more of the traffic event delays;
calculating a new route from the current location to the destination location, the new route having a new travel time;
comparing the new travel time of the new route to a remaining travel time of the first route from the current location to the destination location plus the travel delay; and
outputting the new route if the new travel time is less than the remaining travel time plus the travel delay.

11. The method of claim 10, wherein determining the traffic event delay is based on the event code of at least one of the one or more traffic messages, the event code comprising a value indicative of a length of time.

12. The method of claim 10, wherein determining the traffic event delay comprises calculating a length of time based on a speed of traffic and the location code of at least one of the one or more traffic messages.

13. The method of claim 10, further comprising:
comparing the travel delay to a threshold delay; and
determining whether to calculate the new route based on the comparison.

14. The method of claim 10, wherein the traffic messages are in accordance with a standard.

15. The method of claim 10, wherein the traffic event delay is based on a traffic message provider.

16. The method of claim 10, wherein calculating the travel delay based on one or more traffic event delays is by summing the one or more traffic event delays.

17. A computer readable medium having embodied thereon instructions executable by a processor for performing a method for calculating a route based on traffic events,
the method comprising:
determining a current location of a navigation device;
receiving one or more traffic messages each having an event code and a location code;
determining a traffic event delay for each of the one or more traffic messages where the location code corresponds to a remaining segment of a first route from an origin location to a destination location;
calculating a travel delay based on one or more of the traffic event delays;
calculating a new route from the current location to the destination location, the new route having a new travel time;
comparing the new travel time of the new route to a remaining travel time of the first route from the current location to the destination location plus the travel delay; and
outputting the new route if the new travel time is less than the remaining travel time plus the travel delay.

18. The computer readable medium of claim 17, wherein the method further comprises:
comparing the travel delay to a threshold delay; and
determining whether to calculate the new route based on the comparison.

19. The computer readable medium of claim 17, wherein determining the traffic event delay is based on the event code of at least one of the one or more messages, the event code comprising a value indicative of a length of time.

20. The computer readable medium of claim 17, wherein determining the traffic event delay comprises calculating a length of time based on a speed of traffic and the location code of at least one of the one or more traffic messages.
